(19) United States
(12) Patent Application Publication
(10) Pub. No.: US 2005/0073573 A1
(43) Pub. Date: Apr. 7, 2005

(54) Apparatus and method for processing media

(75) Inventors: Roger S. Kerr, Brockport, NY (US); Seung-Ho H. Baek, Pittsford, NY (US); Thomas A. Mackin, Hamlin, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/680,753

(22) Filed: Oct. 7, 2003

(51) Int. Cl. B41J 2/45

(52) U.S. Cl. 347/238

(57) ABSTRACT

An apparatus (10) for processing media contains microcapsules (46) which contain a first segmented rupturing roller (110) having multiple roller segments. A second segmented rupturing roller (112) has multiple roller segments. The roller segments on the first segmented rupturing roller are offset from roller segments on the second rupturing roller. The multiple roller segments rupture unexposed microcapsules (40) in the media.

### FIELD OF THE INVENTION

The present invention relates in general to an image-forming apparatus and in particular to producing images by rupturing unexposed microcapsules in a photosensitive media by applying pressure with a magnetically loaded roller.

### BACKGROUND OF THE INVENTION

Image-forming apparatus that process photosensitive materials that include microcapsules containing image-forming materials are well known in the art. In this type of apparatus microcapsules are image wise exposed to radiation from an exposure device based on imaging information sent to the exposure device. The photosensitive microcapsules encapsulating the imaging material become hardened when exposed to radiation from the exposure device. Microcapsules that are not exposed by the radiation, and hence do not become hardened, are ruptured by applying pressure. The image-forming material from the ruptured microcapsules is released to begin the development: of the desired image. Image-forming apparatus that employ photosensitive microencapsulated imaging materials are disclosed in U.S. Pat. Nos. 4,399,209; 4,416,966; 4,766,050; 5,783,353; and 5,916,727.

### SUMMARY OF THE INVENTION

Briefly, according to one aspect of the present invention an apparatus for processing media contains microcapsules which contain a first segmented rupturing roller having multiple roller segments. A second segmented rupturing roller has multiple roller segments. The roller segments on the first segmented rupturing roller are offset from roller segments on the second rupturing roller. The multiple roller segments rupture unexposed microcapsules in the media.

Media passes between the first and second segmented roller wherein a force is applied to the independent roller segments in both the first segmented roller and the second segmented roller wherein independent roller segments in both the first segmented roller and the second segmented roller ruptures unexposed microcapsules in the media to form an image within the photosensitive media.

### BRIEF DESCRIPTION OF THE DRAWINGS

A more complete understanding of the invention and its advantages will become apparent from the detailed description taken in conjunction with the accompanying drawings, wherein examples of the invention are shown, and identical reference numbers have been used, where possible, to designate identical elements that are common to the figures referenced below:

FIG. 1 is a schematic, cross sectional view of an imaging apparatus according to the present invention;

FIG. 2 is a schematic, cross sectional view of an image exposure device used in the imaging apparatus shown in FIG. 1;

FIG. 3 shows a ferrous load plate and a segmented rupturing roller having magnetic load segments and rupturing roller segments according to the present invention;

FIG. 4 shows a side view of the ferrous load plate and a segmented rupturing roller shown in FIG. 3;

FIG. 5 shows a pair segmented rupturing with at least one of the segmented rupturing roller being magnetically loaded according to the present invention;

FIG. 6 shows a side view of a pair segmented rupturing with at least one of the segmented rupturing roller being magnetically loaded in FIG. 5;

FIG. 7 shows dual flanged ferrous rupturing roller and magnetic load bar suitable for multi-pass rupturing according to the present invention;

FIG. 8 shows two segmented rupturing rollers each having an external pressure load roller according to the present invention; and

FIG. 9 shows two segmented rupturing rollers each having an internal loading pressure according to the present invention.

### DETAILED DESCRIPTION OF THE INVENTION

The present invention will be directed in particular to elements forming part of, or in cooperation more directly with an apparatus in accordance with the present invention. It is to be understood that elements not specifically shown or described may take various forms well known to those skilled in the art.

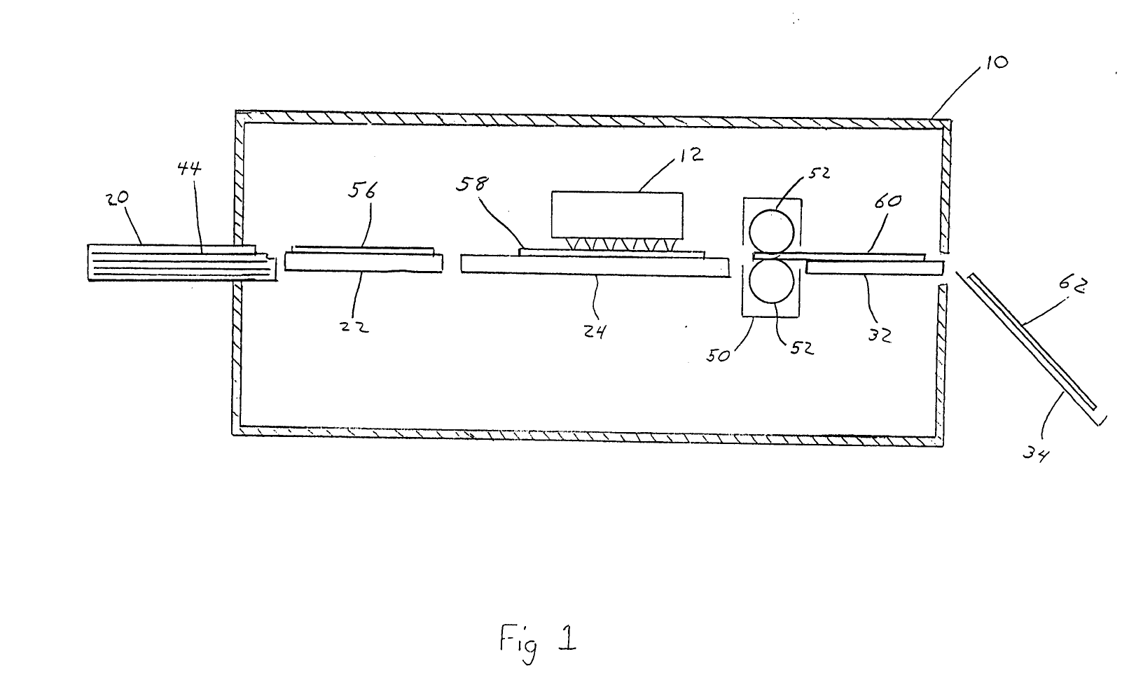

Referring now to FIG. 1 a schematic, cross sectional view of an imaging apparatus 10 for exposing photosensitive media 44 utilizing an image exposure device 12 is shown. Photosensitive media 44 is removed from media tray 20 to the preheat station 22. Once the preheat step is complete the preheated photosensitive media 56 proceeds to the exposure station 24 to be image wise exposed by image exposure device 12. The exposed photosensitive media 58 is then passed through the microcapsule rupturing device 50 where pressure is applied by microcapsule rupturing rollers 52. The developed photosensitive media 60 is then passed to the post heating station 32 and from there to the media exit tray 34 as a competed image 62.

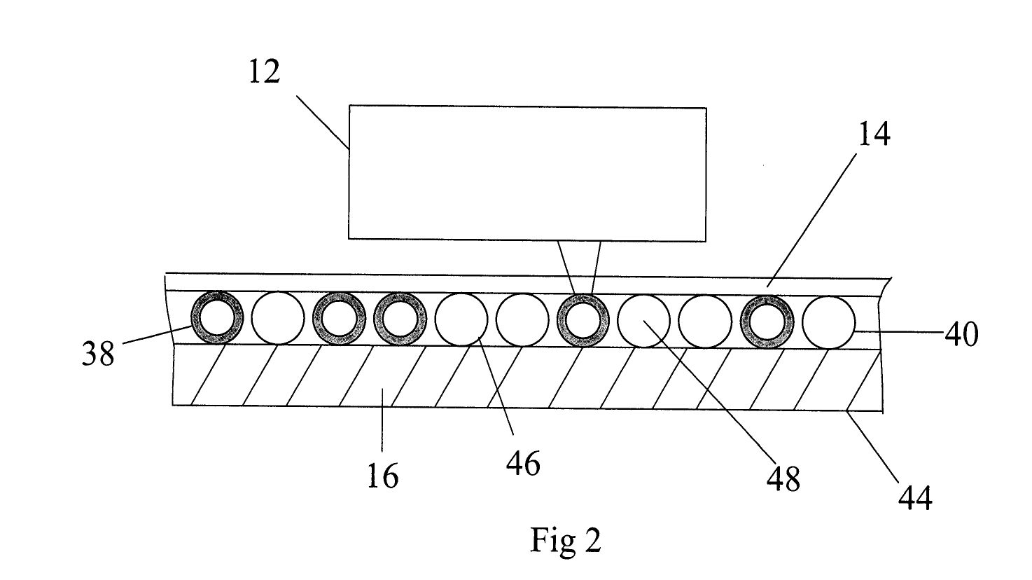

FIG. 2 shows a schematic, cross sectional view of image exposure device 12 shown in FIG. 1. Image exposure device 12 exposes photosensitive media 44, which has a plurality of microcapsules 46 with an image-forming material 48 encapsulated within the microcapsules 46. The microcapsules are coated on support base 16 and have an overcoat 14. Image wise exposure of the selected microcapsules 46 hardens microcapsules 46. Exposed microcapsules 38 when processed through a microcapsule rupturing device 50 that utilizes microcapsule rupturing roller 52, shown in FIG. 1, are not ruptured. The unexposed microcapsules 46 are ruptured releasing image-forming material 48 encapsulated within the unexposed microcapsules 40 to form an image within the photosensitive media 44.

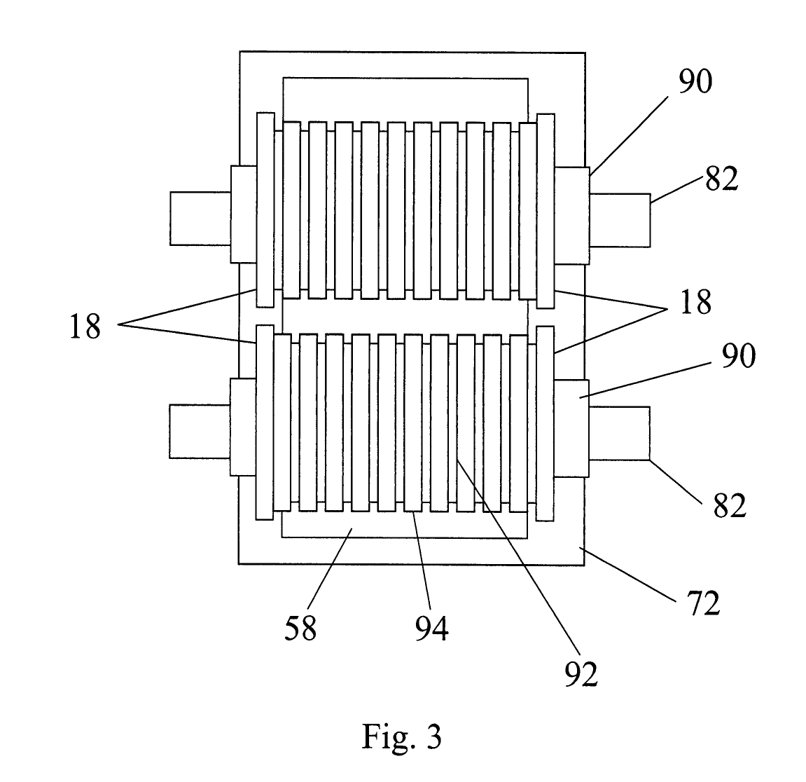

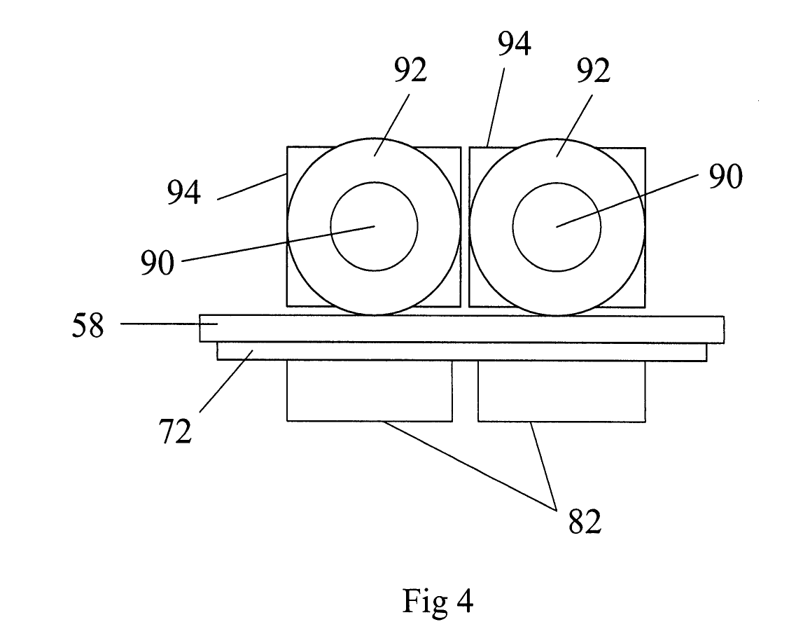

FIGS. 3 and 4 show a segmented rupturing roller 90 having alternating rupturing roller segments 92 and ferrous load segments 94 that are allowed to apply pressure to exposed photosensitive media 58 independently of each other, with exposed photosensitive media 58 between the segmented rupturing roller 90 and the skid plate 72. The magnetic bar 82 creates a force of attraction between the segmented rupturing roller 90 by means of the ferrous load segments 94 and magnetic bar 82, which ruptures any unexposed microcapsules 40 within exposed photosensitive media 58 as exposed photosensitive media 58 passes between the segmented rupturing roller 90, skid plate 72, and magnetic bar 82. The ruptured microcapsules release image-forming material 48 encapsulated within the unexposed microcapsules 40 to form an image within the photosensitive media 44.

Entrance flange 18 on both ends of the segmented rupturing roller 90 maintain a fixed distance between the segmented rupturing roller 90 and the skid plate 72. This is necessary so that exposed photosensitive media 58 is allowed to pass between the segmented rupturing roller 90 and the skid plate 72 since the attraction force between the segmented rupturing roller 90 and the magnetic bar 82 would make it difficult to separate the surfaces of the ferrous rupturing roller 42 and the skid plate 72 if they were allowed to contact each other with no exposed photosensitive media 58 present.

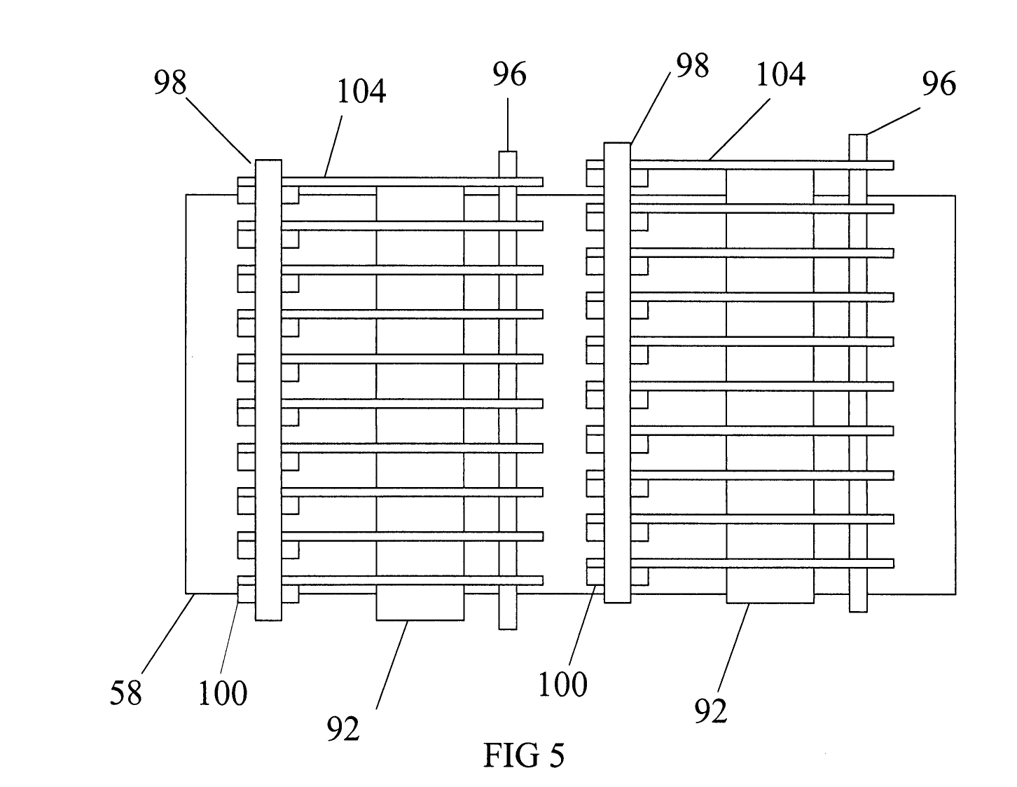

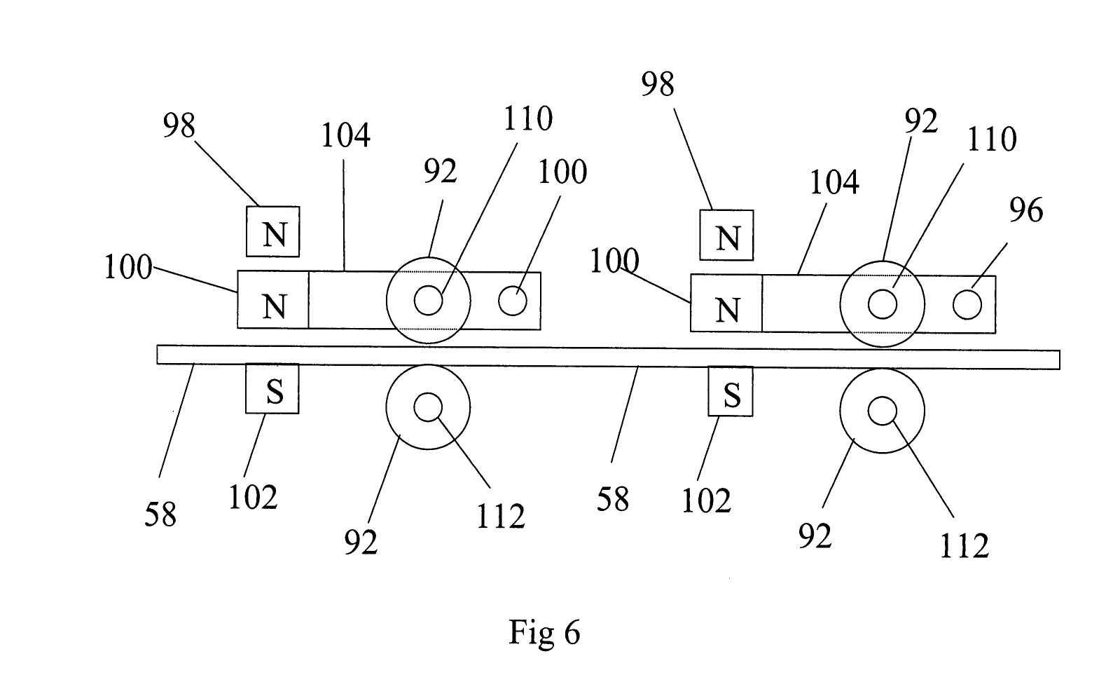

FIGS. 5 and 6 show an upper segmented rupturing roller 110 and lower segmented rupturing roller 112 both having alternating rupturing roller segments 92 which can be made of plastic, and load arms 104 that apply pressure to exposed photosensitive media 58 independently of each other with the load arm 104 pivoting about pivot 96, with exposed photosensitive media 58 between the segmented rupturing roller 90 and the skid plate 72. The second magnet 100 and the third magnet 102 creates a force of attraction between them and apply a load to the upper segmented rupturing roller 110 and lower segmented rupturing roller 112 which ruptures any unexposed microcapsules 40 within exposed photosensitive media 58 as exposed photosensitive media 58 passes between the upper segmented rupturing roller 110 and lower segmented rupturing roller 112 releasing image-forming material 48 encapsulated within the unexposed microcapsules 40 to form an image within the photosensitive media 44. The first magnet 98 is polarized such it is in repulsion with second magnet 100 that if exposed photosensitive media 58 varies in thickness a repulsive force will be applied to the upper segmented rupturing roller 110 and lower segmented rupturing roller 112 to compensate. Entrance flange 18 on both ends of the segmented rupturing roller 90 maintain a fixed distance between the segmented rupturing roller 90 and the skid plate 72. This is necessary so that exposed photosensitive media 58 is allowed to pass between the segmented rupturing roller 90 and the skid plate 72 since the attraction force between the segmented rupturing roller 90 and the magnetic bar 82 would make it difficult to separate the surfaces of the ferrous rupturing roller and the skid plate 72 if they were allowed to contact each other with no exposed photosensitive media 58 present.

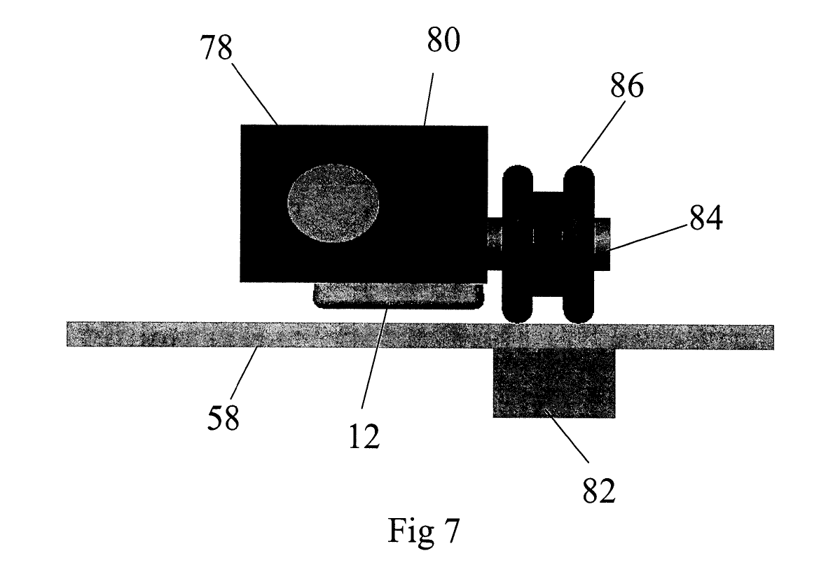

FIG. 7 shows an image exposure device 12 mounted on mounting block 80 that translates along mounting shaft 84. Dual flanged ferrous rupturing roller 86 rides on mounting shaft 84 as the exposure device 12 is translated along translation shaft 78, while exposing photosensitive media 58, and is attracted to magnetic bar 82. Magnetic bar 82 creates a force of attraction between the dual flanged ferrous rupturing roller 86 and magnetic bar 82, which ruptures any unexposed microcapsules 40 within exposed photosensitive media 58 as exposed photosensitive media 58 passes between the dual flanged ferrous rupturing roller 86 and magnetic bar 82 releasing image-forming material 48 encapsulated within the unexposed microcapsules 40 to form an image within the photosensitive media 44.

Although the embodiments shown thus far have used permanent magnets, electromagnets have some advantages in certain situations. For example, electromagnets allow the amount of force exerted on exposed photosensitive media 58 to be varied. This may be necessary as changes are made at the factory to alter or enhance the materials used for the microcapsules contained in exposed photosensitive media 58. Using electromagnetic rollers and electromagnetic device to exert pressure on the media also eliminates the need for flanges at each end of the roller. The pressure on the media can be varied with the electromagnetic devices to exert the proper pressure to crush the unexposed microcapsules 40 and the electromagnets could be deenergized to force the rollers apart when new media is loaded. Also, the field on one of the rollers or both of the rollers could be reversed to electro-magnetically force the rollers apart.

The permanent magnets described in the present invention may be made of a number of different materials known in the art including rare-earth elements. For example, a permanent magnet may be made of a rare-earth material such as neodymium-iron-boron (NdFeB).

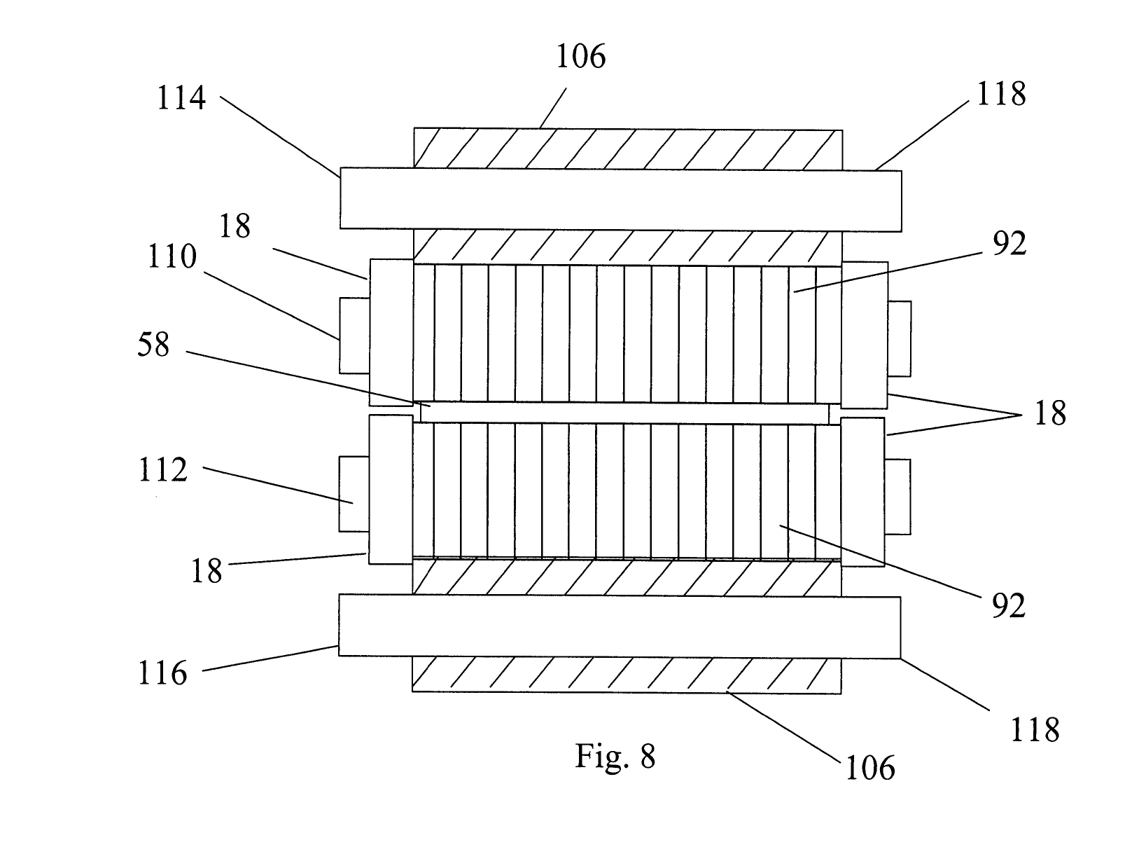

FIG. 8 shows an upper segmented rupturing roller 110 and lower segmented rupturing roller 112 both having rupturing roller segments 92 which can be made of plastic, but not limited to, with exposed photosensitive media 58 between the upper segmented rupturing roller 110 and lower segmented rupturing roller 112. Upper pressure roller 114 and lower pressure roller 116 both having a deformable rubber layer 106 preferable made from a silicon having a durometor between 30 and 70. Pressure roller load shaft 118 apply pressure to upper segmented rupturing roller 110 and lower segmented rupturing roller 112 such that rupturing roller segments 92 applies pressure to the exposed photosensitive media 58 independently which ruptures any unexposed microcapsules 40 within exposed photosensitive media 58 as exposed photosensitive media 58 passes between upper segmented rupturing roller 110 and lower segmented rupturing roller 112. The ruptured microcapsules release image-forming material 48 encapsulated within the unexposed microcapsules 40 to form an image within the photosensitive media 44.

Entrance flange 18 on both ends of the upper segmented rupturing roller 110 and lower segmented rupturing roller 112 maintain a fixed distance between the upper segmented rupturing roller 110 and lower segmented rupturing roller 112. This is necessary so that exposed photosensitive media 58 is allowed to pass between the upper segmented rupturing roller 110 and lower segmented rupturing roller 112 since the force between the upper segmented rupturing roller 110 and lower segmented rupturing roller 112 would make it difficult to separate the surfaces of the upper segmented rupturing roller 110 and lower segmented rupturing roller 112 if they were allowed to contact each other with no exposed photosensitive media 58 present.

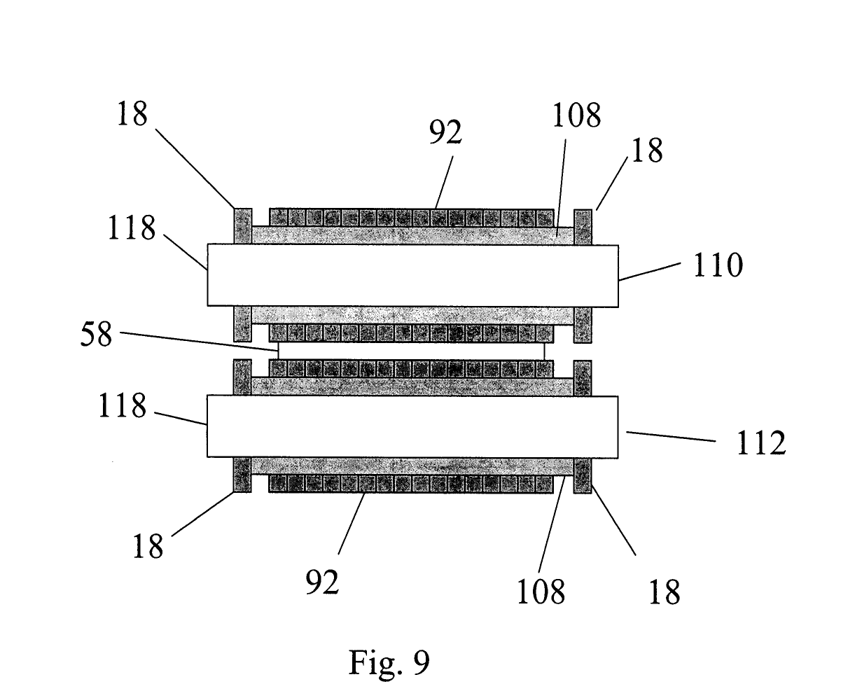

FIG. 9 shows an upper segmented rupturing roller 110 and lower segmented rupturing roller 112 both having rupturing roller segments 92 which can be made of plastic, with exposed photosensitive media 58 between the upper segmented rupturing roller 110 and lower segmented rupturing roller 112. Upper segmented rupturing roller 110 and lower segmented rupturing roller 112 both having an internal deformable rubber layer 108 preferable made from a silicon having a durometor between 30 and 70. Pressure roller shaft 118 applies pressure to rupturing roller segments 92 such that rupturing roller segments 92 can apply pressure to the exposed photosensitive media 58 independently which ruptures any unexposed microcapsules 40 within exposed photosensitive media 58 as exposed photosensitive media 58 passes between upper segmented rupturing roller 110 and lower segmented rupturing roller 112. The ruptured microcapsules release image-forming material 48 encapsulated within the unexposed microcapsules 40 to form an image within the photosensitive media 44.

Entrance flange 18 on both ends of the upper segmented rupturing roller 110 and lower segmented rupturing roller 112 maintain a fixed distance between the upper segmented rupturing roller 110 and lower segmented rupturing roller 112. This is necessary so that exposed photosensitive media 58 is allowed to pass between the upper segmented rupturing roller 110 and lower segmented rupturing roller 112 since the force between the upper segmented rupturing roller 110 and lower segmented rupturing roller 112 would make it difficult to separate the surfaces of the upper segmented rupturing roller 110 and lower segmented rupturing roller 112 if they were allowed to contact each other with no exposed photosensitive media 58 present.

The invention has been described in detail with particular reference to certain preferred embodiments thereof, but it will be understood that variations and modifications can be effected within the scope of the invention.

### Parts List

10 imaging apparatus
12 image exposure device
14 overcoat
16 support base
18 entrance flange
20 media tray
22 preheat station
24 exposure station
32 post heating station
34 media exit tray
38 exposed microcapsule
40 unexposed microcapsule
44 photosensitive media
46 microcapsule
48 image-forming material
50 microcapsule rupturing device
52 microcapsule rupturing roller
56 preheated photosensitive media
58 exposed photosensitive media
60 developed photosensitive media
62 completed image
72 skid plate
78 translation shaft
80 mounting block
82 magnetic bar
84 mounting shaft
86 dual flanged ferrous rupturing roller
90 segmented rupturing roller
92 rupturing roller segment
94 ferrous load segment
96 pivot
98 first magnet
100 second magnet
102 third magnet
104 load arm
106 deformable rubber layer
108 internal deformable rubber layer
110 upper segmented rupturing roller
112 lower segmented rupturing roller
114 upper pressure roller
116 lower pressure roller
118 pressure roller load shaft

1. An apparatus for processing media containing microcapsules comprising:
a first segmented rupturing roller having multiple roller segments;
a second segmented rupturing roller having multiple roller segments;
wherein roller segments on said first segmented rupturing roller are offset from roller segments on said second rupturing roller; and
wherein said multiple roller segments rupture unexposed microcapsules in said media.

2. An apparatus as in claim 1 wherein flanges on opposite ends of each of said first and said second rollers maintain a fixed minimum distance between said roller segments on said first segmented rupturing roller and roller segments on said second segmented rupturing roller and a support surface.

3. An apparatus as in claim 2 wherein said flanges maintain said segmented rupturing rollers at a fixed distance sufficient to rupture unexposed microcapsules.

4. An Apparatus as in claim 3 wherein said fixed distance is great enough to ensure that said exposed microcapsules are not ruptured by pressure caused by said force of attraction.

5. An apparatus as in claim 1 wherein roller segments on said first segmented rupturing roller overlap areas on said media not covered by said roller segments on said second segmented rupturing roller.

6. An apparatus as in claim 1 wherein said multiple roller segments on said first and second segmented rupturing rollers are separated by ferrous load segments; and
wherein said ferrous load segments are attracted to at least one magnetic bar located on a side of said media opposite said first and second segmented rupturing rollers .

7. An apparatus for processing media comprised of exposed microcapsules and unexposed microcapsules comprising:
a first segmented rupturing roller having multiple roller segments located on a first side of a media;
a first load arm attached to said first segmented rupturing roller and attached to a first pivot;
a first magnet attached to an end of said first load arm and attracted to a second magnet on a second side of said media; and
wherein a force of attraction between said first and second magnet exerts a force on said load arm which presses said first segmented rupturing roller onto said media and ruptures unexposed microcapsules in said media.

8. An apparatus as in claim 7 wherein said first roller provides pressure on said media based on mutual magnetic attraction sufficient to rupture said unexposed microcapsules.

9. An apparatus as in claim 7 wherein said multiple roller segments are comprised of plastic.

10. An apparatus as in claim 7 wherein a third magnet having a polarity opposite said first magnet which exerts a repulsive force on said first magnet if said media varies in thickness.

11. An apparatus as in claim 9 comprising:
a second segmented rupturing roller having multiple roller segments on a first side of said media and adjacent said first segmented rupturing roller;
a second load arm attached to said second segmented rupturing roller and attached to a second pivot;
a third magnet on an end of said second load arm and attracted to a fourth magnet on a second side of said media;
wherein a force of attraction between said third and fourth magnets exerts a force on said second load arm which presses said first segmented rupturing roller onto said media and ruptures unexposed microcapsules beneath said second segmented rupturing roller.

12. An apparatus as in claim 9 wherein said first and second roller provide pressure on said media based on mutual magnetic attraction sufficient to rupture said unexposed microcapsules.

13. An apparatus for processing media comprised of exposed microcapsules and unexposed microcapsules comprising:
a first segmented rupturing roller having multiple roller segments on a first side of a media;
a second segmented rupturing roller having multiple roller segments on a first side of said media and adjacent said first segmented rupturing roller;
a first load arm attached to said first segmented rupturing roller and attached to a first pivot;
a second load arm attached to said second segmented rupturing roller and attached to a second pivot;
a first magnet attached to an end of said first load arm and attracted to a second magnet on a second side of said media;
a third magnet on an end of said second load arm and attracted to a fourth magnet on a second side of said media;
wherein a force of attraction between said first and second magnet exerts a force on said load arm which presses said first segmented rupturing roller onto said media and ruptures unexposed microcapsules in said media; and
wherein a force of attraction between said third and fourth magnets exerts a force on said load arm which presses said first segmented rupturing roller onto said media and ruptures unexposed microcapsules beneath said second segmented rupturing roller.

14. An apparatus as in claim 13 wherein said first load arm and said second load arm apply pressure to said media independently of each other.

15. An apparatus as in claim 13 wherein said roller segments on said first segmented rupturing roller are offset from roller segments on said second segmented rupturing roller.

16. An apparatus for processing media containing microcapsules comprising:
a first segmented rupturing roller having multiple rupturing roller segments on a first side of said media comprising an internal deformable rubber layer and a first pressure roller;
a second segmented rupturing roller having multiple rupturing roller segments on a second side of said media an internal deformable rubber layer and a second pressure roller; and
wherein pressure exerted by at least one of said pressure rollers shafts ruptures unexposed microcapsules in said media.

17. An apparatus as in claim 16 wherein said internal deformable rubber layer is comprised of a silicon having a durometor between 30 and 70.

18. An apparatus as in claim 16 wherein flanges on both ends of said first and second segmented rupturing rollers maintain a fixed distance between surfaces of said multiple rupturing rollers segments.

19. An apparatus as in claim 16 wherein said multiple rupturing roller segments are plastic.

20. An apparatus as in claim 19 wherein said flanges maintain a fixed distance between said first and second roller sufficient to rupture said unexposed microcapsules while passing said exposed microcapsules between said rollers without rupturing.

21. A method for processing media comprising the steps of:
providing a media with microcapsules;
exposing selected microcapsules;
providing a first segmented rupturing roller having multiple rupturing roller segments separated by multiple magnetic plates;
providing a second segmented rupturing roller having multiple rupturing roller segments separated by multiple magnetic plates; and
passing said media between said first and said second segmented rupturing roller wherein a force of attraction between said magnetic plates ruptures unexposed microcapsules in said media.

22. A method for processing media comprising the steps of:
providing a media with microcapsules;
exposing selected microcapsules;
providing a segmented rupturing roller having multiple rupturing roller segments separated by multiple ferrous plates;
providing a load magnet opposite said segmented rupturing roller; and
passing said media between said segmented rupturing roller and said load magnet wherein a force of attraction between said ferrous plates and said load magnet ruptures unexposed microcapsules in said media.

23. An apparatus for processing media containing microcapsules comprising:
a rupturing roller having multiple flanges;
a load magnet opposite said rupturing roller; and
wherein unexposed microcapsules in said media passing between said rupturing roller and said load magnet are ruptured by a force of attraction between said rupturing roller and said load magnet.
